(19) United States
(12) Patent Application Publication
(10) Pub. No.: US 2020/0186358 A1
(43) Pub. Date: Jun. 11, 2020

(54) PERSISTENT NETWORK DEVICE AUTHENTICATION

(71) Applicant: Syccure Inc., Armonk, NY (US)

(72) Inventors: Thomas Capola, Armonk, NY (US); David Egbert, Tampa, FL (US)

(21) Appl. No.: 16/708,809

(22) Filed: Dec. 10, 2019

Related U.S. Application Data
(60) Provisional application No. 62/778,035, filed on Dec. 11, 2018.

(51) Int. Cl. H04L 9/32; G06F 16/27; H04L 9/30; H04L 29/06

(52) U.S. Cl. CPC H04L 9/3242; G06F 16/27; H04L 9/3247; H04L 63/0876; H04L 9/30

(57) ABSTRACT

A distributed ledger server includes a memory to store a database of network locations associated with registered network devices, the network locations each indexed against a public key and a hardware fingerprint. A processing device is coupled to the memory and is to: receive a request from a first network device to look up a public key and a second hardware fingerprint for a second network device with which the first network device requests to communicate; authenticate the first network device based on at least the network location of the first network device and as having previously registered; retrieve the public key and the second hardware fingerprint that are indexed in association with the second network device; and respond, to the request to the first network device upon successful authentication of the first network device, with the public key and the second hardware fingerprint.

### REFERENCE TO EARLIER FILED APPLICATION

This application claims benefit under 35 U.S. C. § 119(e) of U.S. Provisional Patent Application No. 62/778,035, filed Dec. 11, 2018, and entitled “Network Device Authenticating Systems,” which is incorporated herein by this reference in its entirety.

### TECHNICAL FIELD

The disclosure relates to network authentication of communication devices, and more particularly, to persistent network device authentication.

### BACKGROUND

Modern computer networks continue to expand as thousands of objects, including internet-of-things (TOT) devices, are added so as to be able to draw data from these devices and to control these devices in an increasingly automated world. The price of this growth is an ever-increasing security challenge of authenticating and authorizing so many devices, some of which are older or “legacy” devices where others are built on modern technology. Easier security solutions such as white listing leave many security problems, and such conventional approaches to authentication force applications to inflexibly hardwire security into code.

More secure solutions, such as that employ public key infrastructure (PKI) to facilitate transport layer security (TLS), are difficult and expensive to implement, are processing intensive, and yet remain vulnerable. For example, PKI security by itself involves only initial authentication that allows network devices to begin encrypted communications. After initial authentication, PKI security is vulnerable to man-in-the-middle attacks and spoofing in which an attacker pretends to be one of the authenticated devices and can intercept and possibly alter communications without threat of detection.

### BRIEF DESCRIPTION OF THE DRAWINGS

FIG. 1A is a block diagram of a distributed system of network devices according to an embodiment.

FIG. 1B is a block diagram of a distributed system of network devices according to another embodiment.

FIG. 1C is a block diagrams of interconnected distributed systems of network devices according to various embodiments.

FIG. 2 is a block diagram of major network devices within a communications platform according to an embodiment.

FIG. 3 is a block diagram of a use case of the communications platform illustrated in FIG. 2 according to an embodiment.

FIG. 4 is a flow chart illustrating a method for registration and configuration of network security policies of a network device according to an embodiment.

FIG. 5 is a process flow diagram illustrating a method for registering a network device with a distributed ledger server according to an embodiment.

FIG. 6A is a process flow diagram illustrating a method for initiation of encrypted communications between network devices according to various embodiments.

FIG. 6B is a process flow diagram illustrating a method for persistent authentication of encrypted communications between network devices of FIG. 6A according to various embodiments.

FIG. 7 is a flow chart of a method for a distributed ledger server to authenticate network devices for encrypted communications according to an embodiment.

FIG. 8A is a process flow diagram illustrating a method for initiation of encrypted communications between a mobile application and an application server via a gateway according to an embodiment.

FIG. 8B is a process flow diagram illustrating a method for persistent authentication of encrypted communications between the mobile application and the application server of FIG. 8A according to an embodiment.

FIG. 9 illustrates a block diagram for a computing system according to various embodiments of any of the communication devices disclosed herein.

### DETAILED DESCRIPTION

The present application is related to a combination of message authentication, encryption, and hardware fingerprinting that ensures that messages sent between devices on a network are not altered during transit. These security measures, which will be described in detail, ensure that the ongoing authentication status of a network device is continuously assured, regardless of whether the network device exists in a cloud environment, a screened subnet (also known as a demilitarized zone, or DMZ), a corporate network, on an Internet of Things (IoT) device, as a mobile application, or other walled garden software environment.

The disclosed communications platform features ongoing authentication. For example, each communication between devices may be authenticated with a time-expiring hash that verifies that the message has not been altered. Even if encryption is broken, the communications platform ensures that the communication has not been altered by a man-in-the-middle because the time it takes break the encryption is longer than the selected time for implementation of the authenticated hash.

In various embodiments, the communications platform may provide message integrity through continuous authentication of messages or network transmissions during a network session. That is, the communications platform may verify that each message sent is the message received through hash-based message authentication (HMAC) that involves at least a network location and hardware-based fingerprint of the network device. For example, packets of a network message or transmission may be signed with a contextual-identifier message authentication code (CIMAC), where the CIMAC encodes, within a hash value, a contextual HMAC, a one-time password (OTP), and a public key. The contextual HMAC may be a hash of a combination of two or more of a geo-location estimated from the network location of the network device, a hardware fingerprint of the network device, an application identifier, and a network session identifier. The hardware fingerprint may be specific to hardware being used by the network device for computing or for network communication.

In some embodiments, the CIMAC may further encode a secret key, which is based on a hash of a combination of a previous encryption key and one or more network parameters associated with a previous network session of the first network device. Because of the contextual nature of this information to a previous session, it is more difficult to spoof and can thus provide additional authentication to network messages or packets during an ongoing network communications session.

In additional embodiments, the disclosed communications platform provides for rotating keys, in which network devices can establish a set of available key components and rotate between those key components, in a way agreed upon during initial registration between two devices. The communications platform may further include a distributed ledger server for storing encryption keys, authentication keys, hardware fingerprints, domain names, network locations and corresponding geographic (or “geo”) locations, and a set of vaulting keys for entry on a distributed ledger (DL) (also known as a blockchain). In some embodiments, the DL may be stored in a database (or similar data structure) and information for each network device may be indexed against the network location, e.g., Internet Protocol (IP) address or a geo location estimated from the IP address.

In disclosed embodiments, the communications platform may further support network devices that registered on the DL but whose network communications software does not include encryption or authentication features, as is the case for legacy IoT and other legacy devices. The communications platform may further support network devices that may only support encryption, packet filtering, or both, but not necessarily authentication. The communications platform may further support network devices that may only provide applications programming access through a gateway that shifts the authentication form the application layer to the network layer.

In various embodiments, the disclosed communications platform includes integration with enterprise identity verification tools, which allows the communications platform to continuously verify the identity of the device owner, from transmission to transmission. The communications platform may further include generating/updating of templates that include installation details to enable automated installation across data centers, cloud environments, and virtual machine environments.

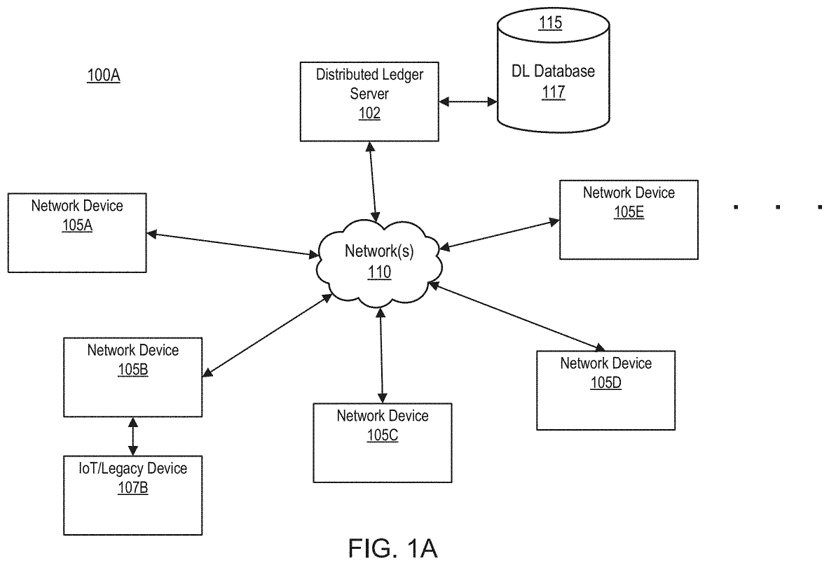

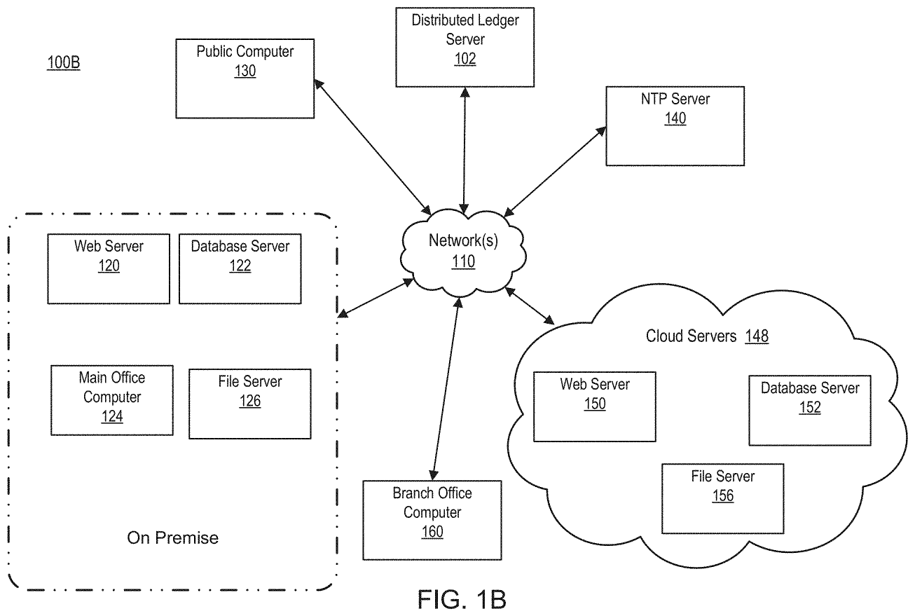

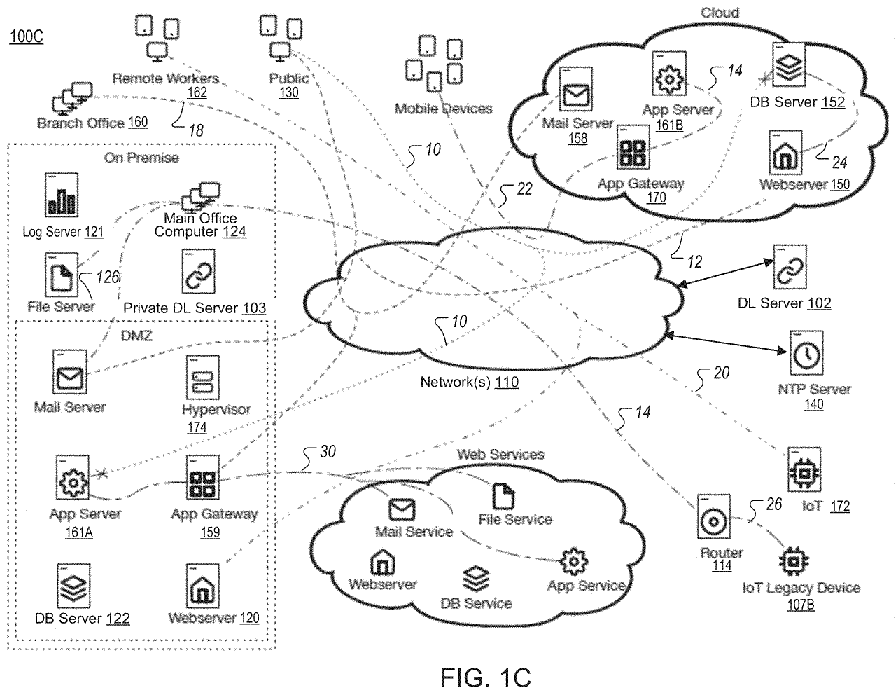

FIG. 1A is a block diagram of a distributed system 100A of network devices according to an embodiment. The distributed system 100A may communicated through one or more networks 110, which may include one or a combination of local area networks (LAN), wide area network (WAN), personal area network (PAN), and the Internet. The distributed system 100A may include a distributed ledger (DL) server 102 having or being coupled to a storage device 115 in which is stored a DL database 117. The DL server 102, which may be a public registry, may store a distributed ledger (e.g., blockchain) of registered network devices in the DL database according various embodiments. The distributed system 100A may further include a number of network devices 105A . . . 105E, each of which may fully or at least partially work with the DL server 102 in order to authenticate itself for encrypted communicate with another network device, as will be described in detail.

In some embodiments, the distributed system 100A may further include one or more IoT or legacy device 107B, which is unable to perform the disclosed authentication and encryption. In these cases, a network device (e.g., the network device 105B as illustrated) may function on behalf of (e.g., as a proxy for) the IoT or legacy device 107B in order to provide the authentication and encryption for the IoT or legacy device 107B. In some examples, the network device 105B that acts as proxy for such an IoT or legacy device 107B is an intelligent router or switch.

FIG. 1B is a block diagram of a distributed system 100B of network devices according to another embodiment. The distributed system 100B may include, for example, may include, on a customer premises, a web server 120, a database server 122 (e.g., SQL server), a main office computer 124, and a file server 126. These on premise machines may communicate over the one or more networks 110 with the DL server 102 (FIG. 1A), with a public computer 130 (or subnet), a network time protocol (NTP) server 140, a branch office computer 160, and a number of cloud servers 148, including but not limited to a web server 150, a database server 152, and a file server 156.

In various embodiments, communication between these various network devices through the network(s) 110 may be categorized in a number of different security categories as follows. Some of the communication links between the network devices may not be blocked by a rule on the DL server 102. This may be represented, for example, as a white listing and may enforce a basic packet filter rule. Further, other communications links may represent communications that are blocked by a rule on the DL server 102. This may be represented, for example, as a black listing and may enforce a basic packet filter rule.

In various embodiments, other communications links represent communications encrypted and authenticated by one or more rules or protocols on the DL server 102. These communications, after initial setup, do not normally require maintenance because the servers update any changes to encryption, authentication, or network location in the registry of the DL database 117.

In disclosed embodiments, the web servers 120 and 150 may respond to hypertext transfer protocol (HTTP) requests from the public computer 130 (or subnet), which may represent a public network in one embodiment. Yet, the web servers 120 and 150 may only permit database communications with servers with which the web servers 120 and 150 have previously been authenticated.

In some embodiments, the database servers 122 and 152 do not communicate with any other server, unless that server has been previously authenticated. So, the database servers 122 and 152 can communicate with each other, and, they can communicate with the web server with which it is paired.

In an embodiment, the public computer 130 can only reach the web server 120 or 150, but not the database server 122 or 152 or the file server 126 or 156, because each of the latter servers is preconfigured with packet filter rules that prevents communication unless explicitly authorized.

In an embodiment, the main office computer 124 can reach the web server 120, for the same reason that the public computer 130 can reach the web server 120. The main office computer 124 may not be allowed to address the database server 122 directly, but may go through the web server 120 to do so. The file server 126 may be the only network device open to the main office computer 124.

In some embodiments, the file servers 126 and 156 communicate with each other through encrypted, mutual authentication. The main office computer 124 or the branch office subnets may also be allowed to mutually authenticate and encrypt communications (but not the public network) through standard packet filter rules.

In various embodiments, the DL server 102 may only be able to communicate with other servers. For example, the DL server 102 may facilitate the initial encryption and authentication requests by providing details to each server. The DL database 117 of the DL server 102 may further be updated with changes to encryption, hardware fingerprinting, network location, and geographic location of other participating servers. This information registered within the DL database 117 further enables updated routing information on the participating servers. Handy access to the NTP server 140 is good for time sensitive computation of HMACs and encryption.

FIG. 1C is a block diagrams of interconnected distributed systems 100C of network devices according to various embodiments. The distributed systems 100C may expand on those illustrated in FIGS. 1A and 1B, in which additional on premise servers are illustrated, as well as a screened subzone (e.g., DMZ). The distributed systems 100C further illustrates the operation of mobile applications on mobile devices, and various web services available in a separate server, which may be located in the cloud.

In disclosed embodiments, the dotted lines 10 represent communications blocked by the distributed security policies, enforced by individual machines as well as by the DL server 102. The dotted lines 10 illustrate that the public computer 130 cannot connect with private file services running in the cloud or an on premise application server because the application server and file server may only connect with white-listed devices.

In disclosed embodiments, the public subnet 130 can register devices on the DL database 117 of the DL server 102. The public subnet 130 can read from the DL database 117 to authenticate, encrypt, generate hardware fingerprint, and geo verify with other registered devices. The dashed line 12 illustrates an example of the public subnet connecting to the web server 150 and mail servers 158, which are configured to allow access to public devices.

In disclosed embodiments, the main office computers 124 are registered on the DL server 102 (e.g., on a DL or blockchain) because the main office computers 124 connect to other devices on the internet. The main office computers 124 can also connect to the private DL (e.g., the DL database 117) via the DL server 102 to access private devices that are on premises or are private servers running in the cloud. The dash-dot line 14 illustrates the main office computers 124 connecting to the mail servers 158 and file servers 126, and also to IoT devices 107B and a router 114 that forwards messages and data packets to the legacy IoT devices 107B.

In disclosed embodiments, the branch office computers 160 are registered on the DL database 117, because they connect to other devices on the internet. The branch office computers 160 can also connect to a private DL server 103 to access private devices on premise or private servers running in the cloud. The long dash line 18 illustrates remote office computers 162 connecting to the mail server 158 and an application gateway 159, which forwards packets and data of application servers 161A and cloud services.

In various embodiments, the remote worker devices are registered on the DL database 117 because they connect to other devices 162 on the internet. The remote worker devices 162 can also connect to the private DL server 103 to access private devices on premise or private servers running in the cloud. The dash-double-dot line 20 illustrates the remote worker devices 162 also connecting to the cloud mail server 158 and the DL server 102, because they connect to other devices on the internet. The remote worker devices 162 can also connect to the private DL server 103 to access private devices on premise or private servers running in the cloud. The dash-double-dot line 20 shows the remote worker devices also connecting to the web server 120 and the IoT devices 172, e.g., via the network(s) 110.

In present embodiments, the NTP server 140 helps synchronize time among all of the network devices, thereby allowing time sensitive rotation and expiration of key components. Further, an application gateway 170 in the cloud allows remote applications to connect to application server(s) 161B. The double-long-dash-one-short-dash line 22 illustrates the connection. The App Server and App Gateway are registered on the public blockchain.

In various embodiments, the web server 150 in the cloud allows connections from the public computers 130 and is registered on the DL server 102. The database server 152 in the cloud may be registered on the DL server 102 or the private DL server 103, because only the web server 150 may access the database server 152 server, as illustrated by the extra-long-dash-to-short-dash line 24.

In disclosed embodiments, an IoT device 172 can be configured and loaded with the appropriate software, and, can participate like other devices. Registration on the DL server 102 can also indicate ownership or custodianship of the device. Registration on only the private DL server 103 can also be used if network locations are sensitive. By comparison, the legacy IoT device 107B may not load or configure software. Here, the closest router 114 is configured to intercept and forward network packets on behalf of the legacy IoT device 107B, as illustrated by the extra-long-dash-to-two-short dash line 26.

In some embodiments, a hypervisor 174 can register on behalf of its virtual machines. Either the private DL server 102 or the public DL server 102 may be used to register the hypervisor 174 and/or individual virtual machines, depending on whether access from the internet is desired.

In various embodiments, a log server 121 is configured to receive statistics and notification from the network devices under control of an organization associated with the on premises location(s). This allows monitoring of failed authentications, encryptions, geo locations, and generally the flow of communications along the pre-defined endpoints. This permits real-time visibility of the network(s) 110 and any exceptional activity.

In various embodiments, the application gateway 159 is configured to forward requests for the application server 161A and web services. Each forwarded service and the application gateway 159 can register on the DL server 102, if public facing. Alternately, each forwarded service and the application gateway 159 can register on the private DL serer 103, where forwarded connections are illustrated by the extra-long-dash line 30.

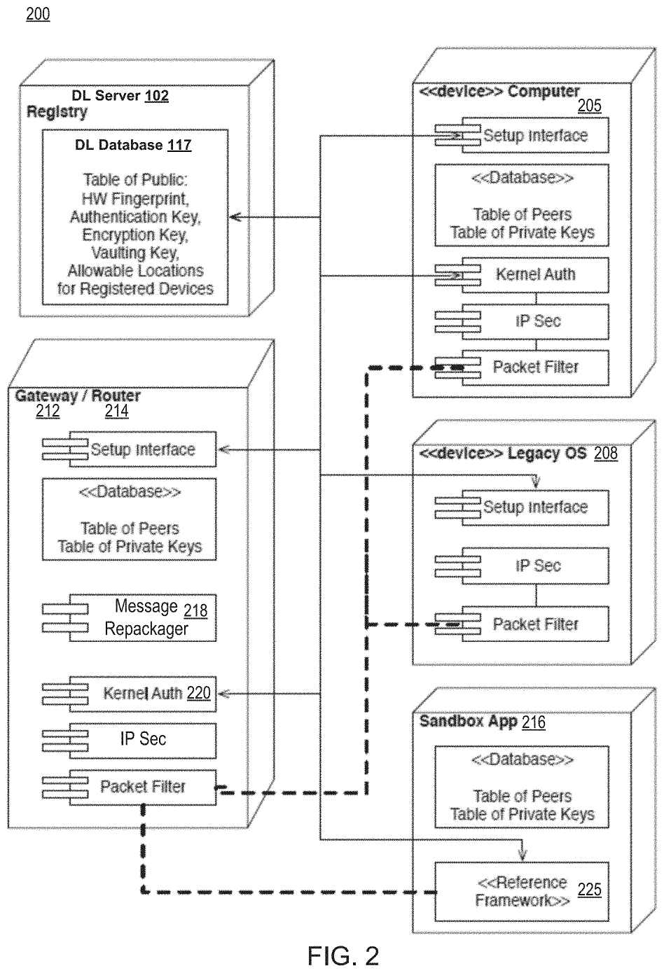

FIG. 2 is a block diagram of major network devices within a communications platform 200 according to an embodiment. In some embodiments, the communications platform 200 includes the DL server 102, a gateway 212, a router 214, a network device 205, a legacy operating system (OS) 208, and a sandbox application 216. The gateway 212 and the router 214 may be similarly configured and are thus illustrated as a single device although may each be a separate network device in the communications platform 200.

In one embodiment, the gateway 212 permits authentication and geo verification between application running at the Open Systems Interconnection (OSI) model layer 7 and kernel modules running at OSI layer 3. A message repackager 218 of the gateway 211 may repackage a messages picked up from sandboxed applications at OSI model layer 7 and retransmit the messages at OSI layer 3.

In the same or related embodiment, the communications system 200 permits interception and forwarding of network transmissions for legacy devices using the router 214 on the same local area network (LAN) as the legacy device. For example, a message repackager 218 the router 214 may intercept the packets coming to and from the legacy device and repackage the packets for compatible communication with other network devices. The router 214 may also perform the authentication, encryption, hardware fingerprinting (or profiling), and other functions on behalf of the legacy device.

In various embodiments, the gateway 212 and/or the router 214 also include a kernel authority 220, which may be a custom kernel loadable module that performs authentication, hardware fingerprinting, and geo verification. A reference framework 225 may enable authentication, hardware fingerprinting, and geo verification for closed applications environment, like the iPhone, web services, cloud services, and software-as-a-service (SaaS) applications.

A setup interface illustrated in several of the network devices illustrated in FIG. 2 may allow automated setup of network communication, system logs, installed software, and DL-related information. An IP security (IP Sec) component illustrated in several of the network devices may represent Internet Protocol Security (IPsec), which is a secure network protocol suite that authenticates and encrypts the packets of data sent over an Internet Protocol network.

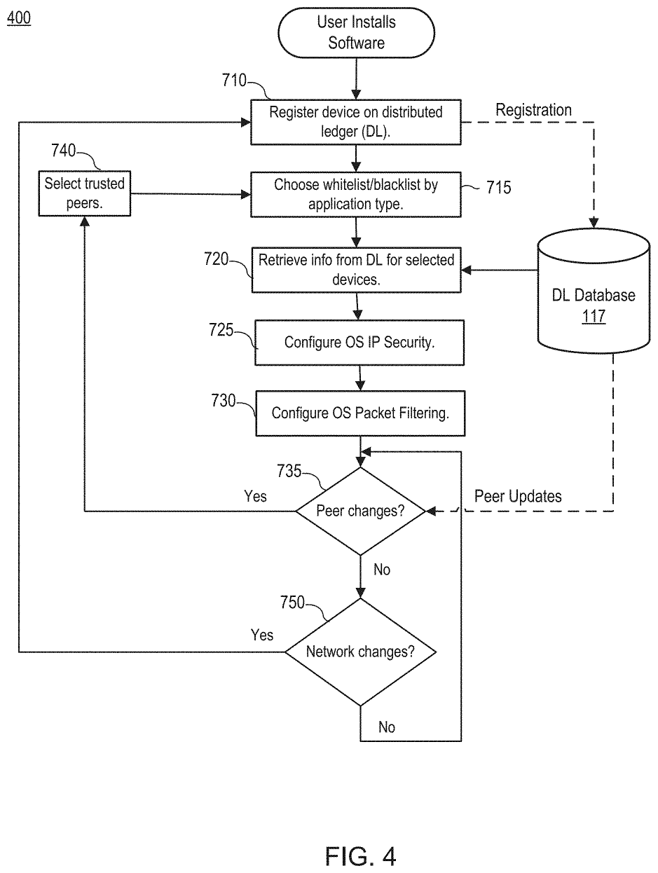

In various embodiments, a packet filter component illustrated in several of the network devices enables filtering packets according to security-related rules/policies depending on which network device and which rules/policies govern a particular communication link. Further, several of the network devices may also include a database such as a table of peers with which each is authenticated to communicate and a table of private keys that the network device has generated for use in private encrypted communications, where this information will be shared with the DL server 102 upon registration, as will be discussed in more detail with reference to FIG. 4.

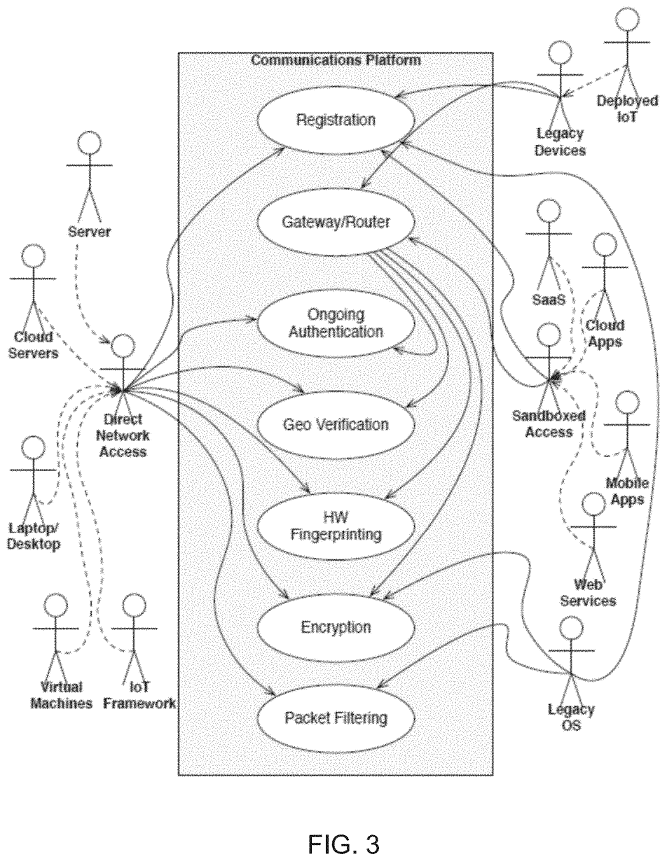

FIG. 3 is a block diagram of a use case 300 of the communications platform illustrated in FIG. 2 according to an embodiment. The use case 300 illustrates four kinds of participating devices in the communications platform 200, including computers (which can include virtual machines as well as bare metal machines) that permit dynamically loadable kernel modules, computing devices (which can include virtual devices) that permit configuration of encryption (IPSec) and packet filtering (PF), application platforms that permit sand-boxed application development, and devices that do not permit end-user program loading, such as legacy devices and deployed IoT. In computer security, a “sandbox” is a security mechanism for separating running programs, usually in an effort to mitigate system failures or software vulnerabilities from spreading.

FIG. 4 is a flow chart illustrating a method 400 for registration and configuration of network security policies of a network device according to an embodiment. The method 400 may be performed by processing logic that may comprise hardware (e.g., circuitry, dedicated logic, programmable logic, microcode, etc.), firmware, software (e.g., executed code) or a combination thereof. In one implementation, the method 400 is performed by a network device such as one of the network devices 105A . . . 105E of FIG. 1A or of the network devices illustrated and discussed with reference to FIG. 1B or FIG. 1C.

With reference to FIG. 4, a user may first install software on the network device that enables specific communication with the DL server 102 for purposes of registration. The processing logic can then be operation of the software on the network device. At operation 710, the processing logic registers the network device on the DL server 102, e.g., by providing certain types of information such as a network location, a geo location, a hardware fingerprint, an application identifier, and the like. This type of information may be stored in the DL database 117 and indexed against the network location of the network device, e.g., an IP address or a geo location estimated based on the IP address. At operation 715, the processing logic chooses a whitelist and/or a black list based on application type. In some embodiments, the setup of the whitelist or blacklist may be automated using network communications, system logs, installed software, and DL-based information.

With continued reference to FIG. 4, at operation 720, the processing logic retrieves information from the DL database 117 for selected network devices (e.g., those that are identified in the blacklist and whitelist) that are going to be designated as either peers with whom the network device will be authenticated for secured communications or as excluded devices. At operation 725, the processing logic configures OS IP security (e.g., IPSec) related to the peer network devices. At operation 730, the processing logic configures OS packet filtering, e.g., based on policy-based rules.

At operation 735, the processing logic determines whether something related to a registered peer network device has changed (e.g., some information or data indexed against the network location for the network device when it registered). If there has been a change, at operation 740, the processing logic selects trusted peers again (and perhaps adjusts who is still trusted based on the change), and loops back to operation 715 in order to optionally update the whitelist and/or blacklist. If there has been no peer changes, at operation 750, the processing logic determines whether there have been network changes. If there have been, the processing logic loops back to operation 710 to re-register the network device on the DL server 102 as previously discussed. Otherwise, the method 400 loops back and continues to monitor for peer network device or network-related changes that may require additional updates to registration or black or white listing.

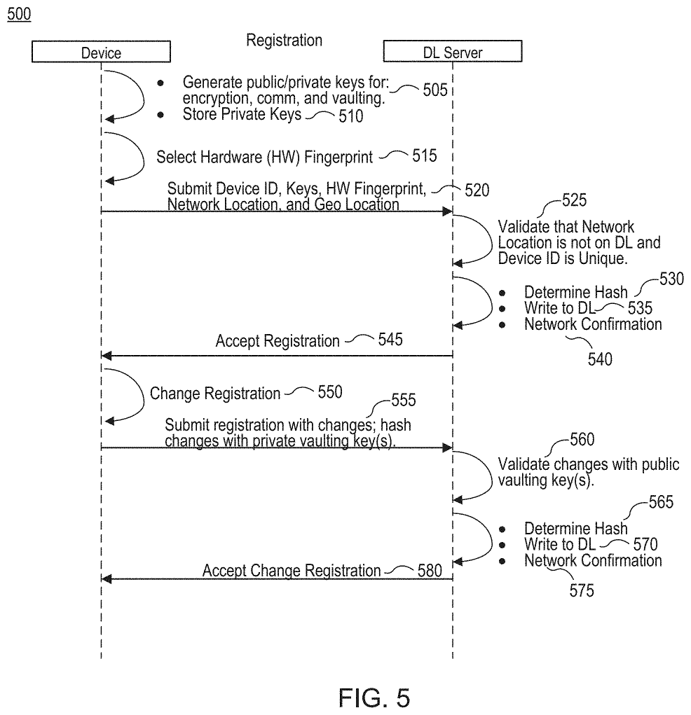

FIG. 5 is a process flow diagram illustrating a method 500 for registering a network device with a distributed ledger server according to an embodiment. The method 500 may be performed by processing logic that may comprise hardware (e.g., circuitry, dedicated logic, programmable logic, microcode, etc.), firmware, software (e.g., executed code) or a combination thereof. In one implementation, the method 500 is performed in part by a network device such as one of the network devices 105A . . . 105E of FIG. 1A or of the network devices illustrated and discussed with reference to FIG. 1B or FIG. 1C. Further, the method 500 is performed in part by a distributed ledger server, such as the DL server 102 and/or the private DL server 103 of FIGS. 1A-1C.

With reference to FIG. 5, at operation 505, the processing logic of the network device generates public and private keys for encryption, communication (e.g., authentication), and vaulting (e.g., securing data within the DL database 117). At operation 510, the processing logic of the network device stores these private keys. At operation 515, the processing logic of the network device selects a hardware (HW) fingerprint. This means that the network device selects what combination of hardware features to combine into the HW fingerprint that will be used for authentication. Some examples include a type of processor, an amount of memory, an OS identifier, a physical layer (PHY) identifier, or the like hardware or firmware, whether variable or not. At operation 520, the processing logic of the network device submits the device identifier (ID), keys, HW fingerprint, network location, and geo location to the DL server.

With continued reference to FIG. 5, at operation 525, the processing logic of the DL server validates that the network location is not on in the DL database 117 and that the device ID is unique, e.g., different than those already stored in the DL database 117. At operation 530, the processing logic of the DL server determines a hash of a combination of the information registered for the network device. At operation 535, the processing logic of the DL server writes the hash of this information to the DL server. At operation 540, the processing logic of the DL server performs a network confirmation of the network location and identification of the network device. At operation 545, the processing logic of the DL server sends a notification to the network device of acceptance of the registration.

At operation 550, the processing logic of the network device changes the registration on the DL server, e.g., has a change or update to the information used to register the network device. At operation 555, the processing logic of the network device submits the registration with the changes and hashes the changes with one or more of the private vaulting keys.

At operation 560, the processing logic of the DL server validates the changes to the registration of the network device with the private vaulting key(s). At operation 565, the processing logic of the DL server determines a hash of the updated registration information. At operation 570, the processing logic of the DL server writes the hashed information to the DL database 117, e.g., indexed against the network location of the network device. At operation 575, the processing logic of the DL server performs a network confirmation of the network location and identification of the network device. At operation 580, the processing logic of the DL server sends a notification to the network device of acceptance of the updated registration.

With reference to mutual authentication using the DL server 102 or private DL server 103 as an intermediary, the transmitting device may be able to employ a number of authenticating sources listed in the rows of Table 1 while the receiving device may also employ a number of authenticating sources listed in the columns of Table 1. These sources of authentication may vary depending on what type of network device is doing the authenticating and whether that network device is transmitting or receiving, as illustrated in Table 1.

TABLE 1

| | Receive | | | | |
|---|---|---|---|---|---|
| Transmit | Computer | App via Gateway | Legacy OS | Legacy Device | Legacy Device via Router |
| Computer | 1. White/Blacklisting | 1. White/Blacklisting | 1. White/Blacklisting | 1. White/Blacklisting | 1. White/Blacklisting |
| | 2. Ongoing Auth | 2. Ongoing Auth | 3. Geo Verification | 3. Geo Verification | 2. Ongoing Auth |
| | 3. Geo Verification | 3. Geo Verification | 5. Encryption | 6. Packet Filtering | 3. Geo Verification |
| | 4. HW Fingerprinting | 4. HW Fingerprinting | 6. Packet Filtering | | 4. HW Fingerprinting |
| | 5. Encryption | 6. Packet Filtering | | | 5. Encryption |
| | 6. Packet Filtering | | | | 6. Packet Filtering |
| App via | 1. White/Blacklisting | 1. White/Blacklisting | 1. White/Blacklisting | 1. White/Blacklisting | 1. White/Blacklisting |
| Gateway | 2. Ongoing Auth | 2. Ongoing Auth | 3. Geo Verification | 3. Geo Verification | 2. Ongoing Auth |
| | 3. Geo Verification | 3. Geo Verification | | | 3. Geo Verification |
| | 4. HW Fingerprinting | 4. HW Fingerprinting | | | 4. HW Fingerprinting |
| Legacy OS | 1. White/Blacklisting | 1. White/Blacklisting | 1. White/Blacklisting | 1. White/Blacklisting | 1. White/Blacklisting |
| | 5. Encryption | 5. Encryption | 5. Encryption | 6. Packet Filtering | 5. Encryption |
| | 6. Packet Filtering | 6. Packet Filtering | 6. Packet Filtering | | 6. Packet Filtering |
| Legacy Device | N/A | N/A | N/A | N/A | N/A |
| Legacy Device | 1. White/Blacklisting | 1. White/Blacklisting | 1. White/Blacklisting | 1. White/Blacklisting | 1. White/Blacklisting |
| via Router | 2. Ongoing Auth | 2. Ongoing Auth | 3. Geo Verification | 3. Geo Verification | 2. Ongoing Auth |
| | 3. Geo Verification | 3. Geo Verification | 5. Encryption | 6. Packet Filtering | 3. Geo Verification |
| | 4. HW Fingerprinting | 4. HW Fingerprinting | 6. Packet Filtering | | 4. HW Fingerprinting |
| | 5. Encryption | 6. Packet Filtering | | | 5. Encryption |
| | 6. Packet Filtering | | | | 6. Packet Filtering |

The move to cloud and software-as-a-service applications, coupled with software defined networks (SDNs) and Network Function Virtualization (NFV) brings agility, efficiency, and lower costs to maintain ever-growing networks. The cloud architecture separates the application plane (e.g., SDN applications) from the control plane (e.g., SDN controller), and from the data plane (e.g., networking elements, including data servers and the like). This distribution of these elements and the use of virtualization opens up a distributed network to additional points of potential attack such as a DOS attack, application programming interface (API) exploitation, personal hijacking (e.g., identifier binding attacks), and spoofing attacks such as Address Resolution Protocol (ARP) attacks.

Persona hijacking is a type of computer hacking that breaks the bindings of all layers of the networking stack and fools the network infrastructure into believing that the attacker is the legitimate owner of the victim's identifiers, which significantly increases persistence of the attacker. In embodiments, persona hijacking can spoof a virtual machine (VM) in a virtualized environment, thus taking over as representing a network device in a network that has already been authenticated to communicate. This is a typical hack today, which can be carried out using malware downloaded onto the network device computer. Once another network device in the network thinks the hacked network device is communicating with a legitimate machine, the hacker's machine can gain access to the other network device and thus, ultimately, into the network. This simple example demonstrates how current networks are still vulnerable. Access control in current network environments, e.g., at scale in virtualized environments, are increasingly complex and unsecure. For example, firewalls only work at one level, certificates are complex and cumbersome, and key generation and use is only effective at the OSI layer for which encryption-based protection is written.

Access to networked resources should be authenticated and authorized based on cryptographic identities and context, rather than ambient authority from the network such as provided by certificates. Granting permission and revoking privileges can be based on contextual awareness that can be provided with metadata associated with each network device, and can be performed throughout a network session.

As the concept of cryptographic (or encryption) keys is discussed with reference to the following Figures, an introduction of security protocols and use of various keys is first discussed to provide context of the use of keys in secure communication. Mutual transport layer security (mTLS) was originally named secure sockets layer (SSL) before it was standardized by the Internet Engineering Task Force (IETF) and given the name of TLS as it is known today. Mutual TLS is a form of TLS, implemented in requiring computers to send certificates to each other to establish mutual trust. Operation of mTLS further provides message integrity and confidentiality, but requires a static, centralized trust authority.

Cryptography is employed to communicate securely over the internet: for example, if data is not encrypted, anyone can examine its packets and read confidential information. Using cryptography, data can also be authenticated in order to determine the true sender and can also be checked to see if the data has been modified en-route. One popular method of encryption is called asymmetrical cryptography, which uses two cryptographic keys pieces of information, usually very large numbers—to work properly, one public and one private. The public key can be used to encrypt the data, and the private key can be used to decrypt it. The two keys are related to each other by some complex mathematical formula that is difficult to reverse-engineer by brute force. Asymmetric encryption's popularity stems from the fact that the private key is never revealed, even to a recipient. In many circumstances, this is more secure because the recipient does not have to be trusted. Moreover, asymmetric encryption can also be used for authentication as well as encryption.

Because of the mathematics involved, asymmetrical cryptography takes a lot of computing resources and is typically hundreds of times slower than symmetric encryption. For example, if asymmetrical cryptography was used to encrypt the information in a communications session, a computer and its connection would likely stall or hang for most typical internet interaction. TLS gets around this problem by using asymmetrical cryptography at the very beginning of a communications session to encrypt the conversation. Once initial authentication is established, the server and client then can agree on a single session key (e.g., private key) that both server and client can use to encrypt their packets from that point forward. Encryption using a shared key is called symmetrical cryptography, and is much less computationally intensive than asymmetric cryptography. Because that session key was established using asymmetrical cryptography, the communication session as a whole is much more secure than it otherwise would be, as the session key was not compromised.

The process by which the session key is agreed upon is called a handshake, since it is the moment when the two communicating devices introduce themselves to each other, and is what is at the heart of the TLS protocol. The handshake process, while much more complex, employs the following general steps. First, the client contacts the server and requests a secure connection. The server replies with the list of cipher suites—algorithmic toolkits of creating encrypted connections—that it knows how to use. The client compares this against its own list of supported cipher suites, selects one, and lets the server know that they'll both be using it.

Next, the server provides its digital certificate, an electronic document issued by a third-party certificate authority (or “CA”) confirming the server's identity. The digital certificate provides authentication and contains the server's public cryptographic key. Once the client receives the certificate, it confirms the certificate's authenticity.

Next, using the server's public key, the client and server establish a session key that both will use for the rest of the session to encrypt communication. There are several techniques for doing this. The client can use the public key to encrypt a random number that's then sent to the server to decrypt data, and both parties then use that number to establish the session key. Alternately, the two parties can use what is called a Diffie-Hellman (DH) key exchange to establish the session key. Diffie-Hellman was the precursor to the RSA SecurID by Security Dynamics, later named RSA Security. Both DH and RSA are methods of securely exchanging cryptographic keys (e.g., session keys) over a public channel. As its name implies, the session key is only good for the course of a single, unbroken communications session. If for some reason communications between client and server are cut off—due to a network problem, for instance, or because the client is idle for too long—a new handshake is required to establish a new session key when communication is re-established.

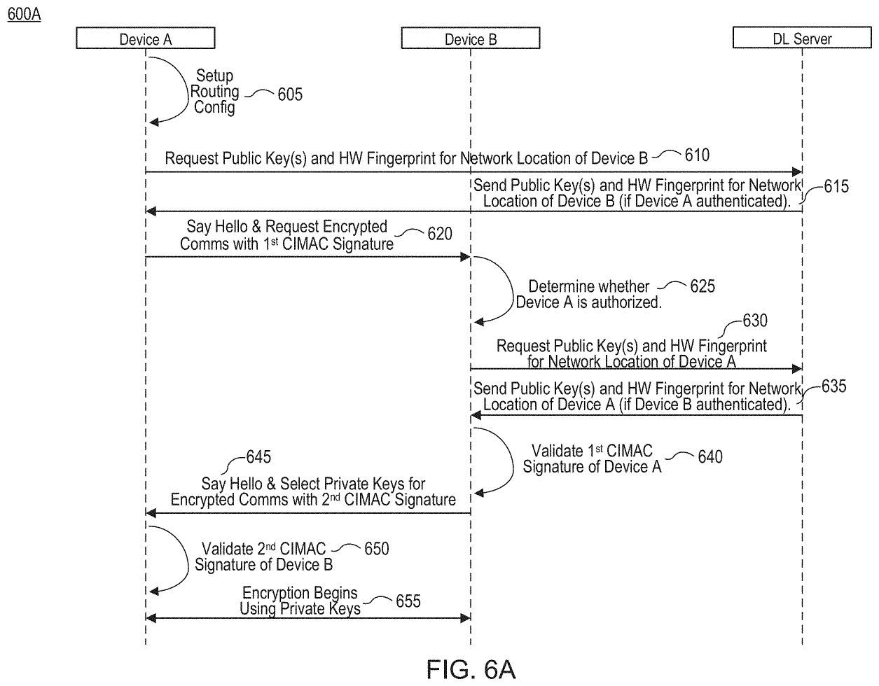

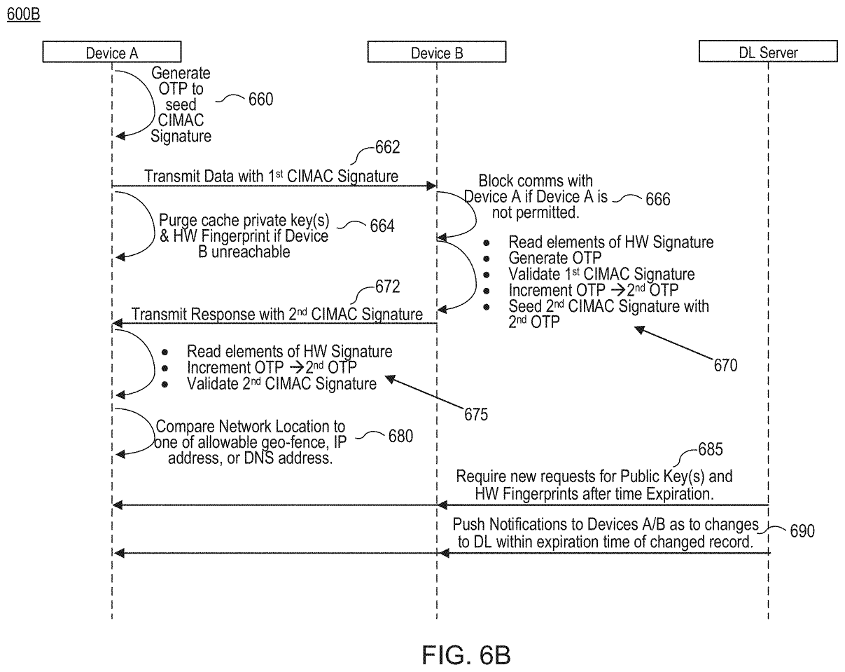

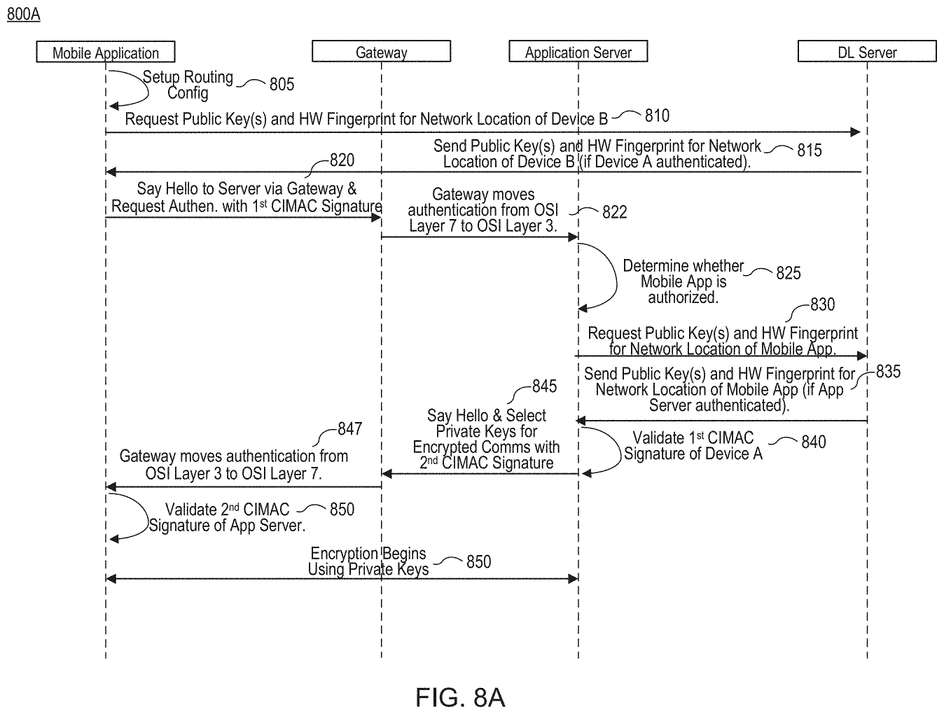

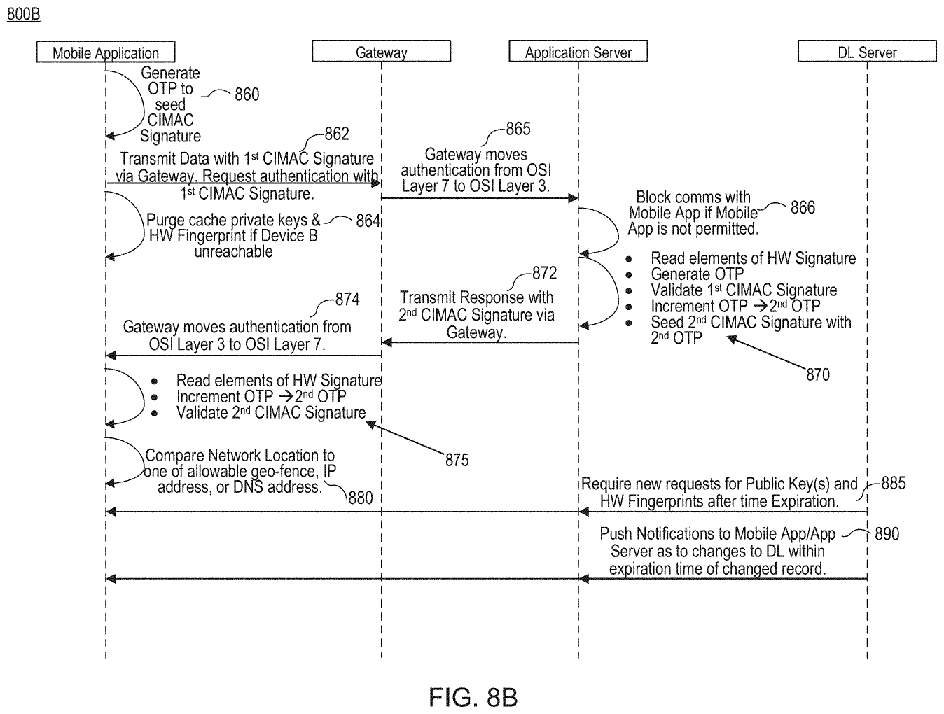

In the following figures, the handshake process (described with reference to FIGS. 6A and 8A) is updated to be performed primarily between two network devices, with use of the DL server 102 as an intermediary from which to obtain certain types of authenticating information about each other. In this way, the DL server 102 may act as a fluid central authority for purposes of authentication and facilitating completion of the handshake process between any two network devices, not only between a client and server, as well as on-going authentication during a network session, as will be discussed with reference to FIGS. 6B and 8B.

FIG. 6A is a process flow diagram illustrating a method 600 for initiation of encrypted communications between network devices according to various embodiments. The method 600 may be performed by processing logic that may comprise hardware (e.g., circuitry, dedicated logic, programmable logic, microcode, etc.), firmware, software (e.g., executed code) or a combination thereof. In one implementation, the method 600 is performed in part by network devices such as the network devices 105A . . . 105E of FIG. 1A or of the network devices illustrated and discussed with reference to FIG. 1B or FIG. 1C. For simplicity of explanation, Device A and Device B are a first network device and a second network device, respectively, that will be referred to attempting to mutually authenticate for encrypted communications. It should be noted that Device A may be the network device 105B and thus be able to act on behalf of a legacy or IoT device that is incapable of one or both of performing disclosed authentication and encryption. Further, the method 600 is performed in part by a distributed ledger server, such as the DL server 102 and/or the private DL server 103 of FIGS. 1A-1C.

At operation 605, a system administrator of Device A, Device B, and other networked devices defines authorized network devices for communication, permissible HW fingerprint attributes, and off-device authorization for one-time password (OTP) seeds. A one-time password, also known as one-time pin or dynamic password, is a password that is valid for only one login session or transaction, on a computer system or other digital device. In various embodiments, an administrative computing device may assign a secret OTP seed, secret HW fingerprint, and key-part rotation for each authorized network device.

At operation 610, the first network device (Device A), which is requesting to communicate with a second network device (Device B), requests, from a distributed ledger server, a public key and a second hardware fingerprint associated with a second network location of the second network device. This information is representative of authentication information that can be requested, as additional or different information or data may be requested from the DL server for purposes of authentication.

At operation 615, the DL server can authenticate the first network device based on at least the network location of the first network device and as having previously registered. Assuming the first network device is authenticated, the DL server sends a public key and HW fingerprint for the network location of the second network device. Accordingly, at operation 615, the first computing device receives, in response to the distributed ledger server authenticating the first network device, the public key and the second hardware fingerprint associated with the second network location.

At operation 620, the first network device (Device A) introduces itself and requests encrypted communications with the second network device (Device B) using a first contextual-identifier message authentication code (CIMAC) signature. Accordingly, the first network device first generates the first CIMAC signature that encodes, within a first hash value, a first contextual hash-based message authentication code (HMAC), a one-time password, and the public key. In some embodiments, the first CIMAC signature may also encode, within the first hash value, a first secret key based on a hash of a combination of a previous encryption key and one or more network parameters associated with a previous network session of the first network device. This additional hash encodes previous network session information, making it more difficult to spoof a current network session of the first network device.

In some embodiments, generating the contextual HMAC may include estimating a first geo-location of the first network device based on a first network location of the first network device, generating a first hardware fingerprint of the first network device, and generating the first contextual HMAC based on taking a hash of a combination of the first geo-location, the first hardware fingerprint, an application identifier, and a network session identifier of the first network device. Other types of contextual (hardware, software, application, network session) information may be used as well in other embodiments.

At operation 625, the second network device (Device B) determines whether the first network device (Device A) is authorized to communicate with the first network device, e.g., based on a white list or via application of a network device access policy. If the first network device is not authorized, the encrypted communication between Device A and Device B is disallowed.

At operation 630, the second network device requests, from the distributed ledger (DL) server, the public key and a first hardware fingerprint associated with a first network location of the first network device. Accordingly, the DL server receives the request from the second network device to look up a public key and a first hardware fingerprint for a first network device. The DL server further authenticates the second network device based on at least the network location of the second network device and as having previously registered. The DL server further retrieves the public key and the first hardware fingerprint that are indexed in association with the first network device.

At operation 635, the DL responds to the request of the second network device upon successful authentication of the second network device by sending the public key and the first hardware fingerprint to the second network device. Accordingly, the second network device receives, in response to the DL server authenticating the second network device, the public key and the first hardware fingerprint associated with the first network location.

At operation 640, the second network device (Device B) validates, before beginning the encrypted communication, the first CIMAC signature using at least the public key, the first hardware fingerprint, and the first network location. This validation, however, can use additional authenticating information received from the DL server.

At operation 645, the second network device (Device B) introduces itself to the first network device (Device A) and selects a private (e.g., session) key for encrypted communications with the first network device. This selection is also transmitted to the first network device, which is to facilitate completion of the handshake process. The messages sent to the first network device may also be signed with a second CIMAC signature, which may generated similarly to the first CIMAC signature, but which may be specific to a network location and a hardware fingerprint of the second computing device, and optionally also to an application identifier and/or a network session identifier.

At operation 650, the first network device (Device A) validates, by the first network device using the public key, the second hardware fingerprint, and the second network location, a response from the second network device that includes a second CIMAC signature specific to the second network device. This validation may therefore validate the second CIMAC signature applied to the message received from the second network device.

At operation 655, the first network device (Device A) may begin encrypted communication with the second network device (Device B) in response using the selected private key. Further, the first network device signs first encrypted data sent to the second network device with the first CIMAC signature. Additionally, the second network device signs second encrypted data send to the first network device with the second CIMAC signature. Use of the CIMAC signature enable continuous authentication during the network session, as will be described with reference to FIG. 6B.

FIG. 6B is a process flow diagram illustrating a method for persistent authentication of encrypted communications between the network devices of FIG. 6A according to various embodiments. At operation 660, the first network device (Device A) generates a one-time password (OTP) usable to seed a CIMAC signature. The first network device may also seed, using the one-time password, generation of a first hash value including a first contextual-identifier message authentication code (CIMAC) signature. The first CIMAC, for example, encodes, within the first hash value, a first contextual hash-based message authentication code (HMAC) and a public key.

At operation 662, the first network device (Device A) transmits, to the second network device, first encrypted data signed with the first CIMAC signature, where the first CIMAC signature is to provide authentication of the first encrypted data. In one embodiment, the first CIMAC signature is appended to the first encrypted data. In another embodiment, the second CIAC signature is encoded within or combined with the encrypted data before being transmitted.

At operation 664, the first network device (Device A) purges any cache private key(s) and a second hardware fingerprint for the second network device (Device B) if the second network device is unreachable, e.g., no response received.

At operation 666, the second network device (Device B) blocks communication with the first network device (Device A) if such communication is not permitted. This may be determined via a look up of a block list of network devices, and determining that the first network device is on that list. This could be an attempted attack or spoof.

At operation 670, the second network device (Device B) may perform a number of processes in order to authenticate the message or data received from the first network device (Device A), e.g., by way of on-going authentication. This may include, but not be limited to, reading elements of a first hardware fingerprint of the first network device that was previously received from a distributed ledger server upon initiation of the encrypted communication and generating the one-time password. The second network device may then validate the first CIMAC signature using the elements of the first hardware fingerprint and the one-time password. The second network device may further increment the one-time password to generate a second one-time password, and seed a second CIMAC signature specific to the second network device using the second one-time password.

At operation 672, the second network device sends, to the first network device, second encrypted data signed with the second CIMAC signature. Once the first network device receives the second encrypted data, e.g., by way of a response to the first network device, at operation 675, the first network device performs a number of processes to authenticate the second encrypted data. To do so, the first network device may read elements of a second hardware signature of the second network device that was previously received from a distributed ledger server upon initiation of the encrypted communication. The first network device may further increment the one-time password to generate the second one-time password, and then validate the second CIMAC signature using the elements of the second hardware signature and the second one-time password.

At operation 680, the first network device compares a second network location of the second network device transmitted with the second encrypted data to one of a geo-fence, an Internet protocol address, or a domain name system (DNS) address for the second network device. In response to failing to validate the second network location, the first network device terminates the encrypted communication with the second network device.

At operation 685, in response to expiration of one of a public key or a hardware fingerprint used for initial authentication between the first network device and the second network device: requiring the first network device to request a second public key and a second hardware fingerprint of the second network device from a distributed ledger server; requiring the second network device to request the second public key and a first hardware fingerprint of the first network device from the distributed ledger server; and mutually authenticating the first network device and the second network device with each using the second public key and one of the second hardware fingerprint and the first hardware fingerprint, respectively.

At operation 690, in response to a change in an item of information indexed against either of the first network location (of the first network device) or the second network location (of the second network device), notify the first network device and the second network device of the change within an expiration time of a record that is changed. This will enable keeping authentication information updated at the network devices that may continue to be used for on-going authentication. The expiration time is made to be shorter than a time required to spoof a connection to one of the network devices using outdated authentication information.

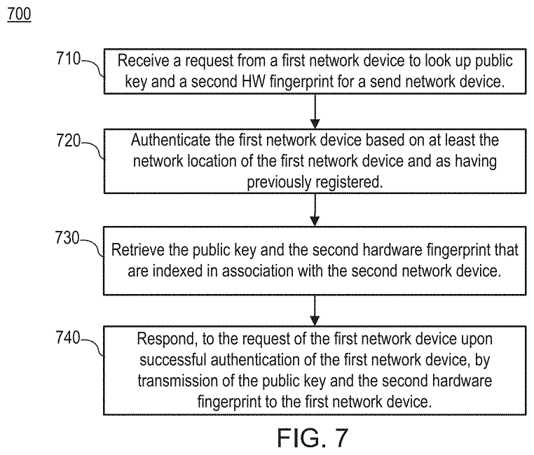

FIG. 7 is a flow chart of a method 700 for a distributed ledger server to authenticate network devices for encrypted communications according to an embodiment. The method 700 may be performed by processing logic that may comprise hardware (e.g., circuitry, dedicated logic, programmable logic, microcode, etc.), firmware, software (e.g., executed code) or a combination thereof. In one implementation, the method 700 is performed by a distributed ledger server, such as the DL server 102 and/or the private DL server 103 of FIGS. 1A-1C. The DL server includes or is coupled to a memory that stores a database of network locations associated with registered network devices, e.g., the DL database 117 of FIG. 1A. The network locations of each network device may be indexed against a public key and a hardware fingerprint for the network device in the DL database.

With reference to FIG. 7, at operation 710, the processing logic receives a request from a first network device to look up a public key and a second hardware fingerprint for a second network device with which the first network device requests to communicate. At operation 720, the processing logic authenticates the first network device based on at least the network location of the first network device and as having previously registered. At operation 730, the processing logic retrieves, from the DL database, the public key and the second hardware fingerprint that are indexed in association with the second network device. At operation 740, the processing logic responds to the request to the first network device upon successful authentication of the first network device, by transmission of the public key and the second hardware fingerprint to the first network device.

FIG. 8A is a process flow diagram illustrating a method 800 for initiation of encrypted communications between a mobile application and an application server via a gateway according to an embodiment. The method 800 may be performed by processing logic that may comprise hardware (e.g., circuitry, dedicated logic, programmable logic, microcode, etc.), firmware, software (e.g., executed code) or a combination thereof. In one implementation, the method 800 is performed in part by network devices such as the network devices 105A . . . 105E of FIG. 1A or of the network devices illustrated and discussed with reference to FIG. 1B or FIG. 1C. For simplicity of explanation, a mobile application and an application server (see FIG. 1C) are a first network device and a second network device, respectively, that will be referred to attempting to mutually authenticate for encrypted communications via a gateway device. Further, the method 800 is performed in part by a distributed ledger server, such as the DL server 102 and/or the private DL server 103 of FIGS. 1A-1C.

At operation 805, a system administrator of the mobile application, the application server, and other networked devices defines authorized network devices for communication, permissible HW fingerprint attributes, and off-device authorization for one-time password (OTP) seeds. A one-time password, also known as one-time pin or dynamic password, is a password that is valid for only one login session or transaction, on a computer system or other digital device. In various embodiments, an administrative computing device may assign a secret OTP seed, secret HW fingerprint, and key-part rotation for each authorized network device.

At operation 810, the first network device (mobile application), which is requesting to communicate with a second network device (application server), requests, from a distributed ledger server, a public key and a second hardware fingerprint associated with a second network location of the second network device. This information is representative of authentication information that can be requested, as additional or different information or data may be requested from the DL server for purposes of authentication.

At operation 815, the DL server can authenticate the first network device based on at least the network location of the first network device and as having previously registered. Assuming the first network device is authenticated, the DL server sends a public key and HW fingerprint for the network location of the second network device. Accordingly, at operation 815, the first computing device receives, in response to the distributed ledger server authenticating the first network device, the public key and the second hardware fingerprint associated with the second network location.

At operation 820, the first network device (mobile application) introduces itself and requests encrypted communications, via the gateway, with the second network device (application server) using a first contextual-identifier message authentication code (CIMAC) signature. Accordingly, the first network device first generates the first CIMAC signature that encodes, within a first hash value, a first contextual hash-based message authentication code (HMAC), a one-time password, and the public key. In some embodiments, the first CIMAC signature may also encode, within the first hash value, a first secret key based on a hash of a combination of a previous encryption key and one or more network parameters associated with a previous network session of the first network device. This additional hash encodes previous network session information, making it more difficult to spoof a current network session of the first network device.

In some embodiments, generating the contextual HMAC may include estimating a first geo-location of the first network device based on a first network location of the first network device, generating a first hardware fingerprint of the first network device, and generating the first contextual HMAC based on taking a hash of a combination of the first geo-location, the first hardware fingerprint, an application identifier, and a network session identifier of the first network device. Other types of contextual (hardware, software, application, network session) information may be used as well in other embodiments.

At operation 822, the gateway moves the authentication of the mobile application from OSI layer 7 to OSI 3 layer. Operation 822 may be performed because, in some embodiments, existing security policies are written at the network (or IP) layer (OSI layer 3) and can avoid being rewritten by moving the authentication from the application layer (OSI layer 7) to the network layer. This enables specific authentication, facilitated by the gateway, of the mobile application by the application server with the help of the DL server.

At operation 825, the second network device (application server) determines whether the first network device (mobile application) is authorized to communicate with the first network device, e.g., based on a white list or via application of a network device access policy. If the first network device is not authorized, the encrypted communication between mobile application and application server is disallowed.

At operation 830, the second network device requests, from the distributed ledger (DL) server, the public key and a first hardware fingerprint associated with a first network location of the first network device, e.g., a mobile device on which the mobile application is running. Accordingly, the DL server receives the request from the second network device to look up a public key and a first hardware fingerprint for a first network device. The DL server further authenticates the second network device based on at least the network location of the second network device and as having previously registered. The DL server further retrieves the public key and the first hardware fingerprint that are indexed in association with the first network device.

At operation 835, the DL responds to the request of the second network device (application server) upon successful authentication of the second network device by sending the public key and the first hardware fingerprint to the second network device. Accordingly, the application server receives, in response to the DL server authenticating the second network device, the public key and the first hardware fingerprint associated with the first network location.

At operation 840, the second network device (application server) validates, before beginning the encrypted communication, the first CIMAC signature using at least the public key, the first hardware fingerprint, and the first network location. This validation, however, can use additional authenticating information received from the DL server.

At operation 845, the second network device (application server) introduces itself to the first network device (mobile application) via the gateway and selects a private (e.g., session) key for encrypted communications with the first network device. This selection is also transmitted to the first network device via the gateway, which is to facilitate completion of the handshake process. The messages sent to the first network device may also be signed with a second CIMAC signature, which may generated similarly to the first CIMAC signature, but which may be specific to a network location and a hardware fingerprint of the second computing device, and optionally also to an application identifier and/or a network session identifier.

At operation 847, the gateway moves authentication of the application server from OSI layer 3 (the network or IP layer) to the OSI layer 7 (the application layer), thereby moving authentication back to the mobile application to complete the secure handshake at the level of the first network device.

At operation 850, the first network device (mobile application) validates, by the first network device using the public key, the second hardware fingerprint, and the second network location, a response from the second network device that includes a second CIMAC signature specific to the second network device. This validation may therefore validate the second CIMAC signature applied to the message received from the second network device.

At operation 855, the first network device (mobile application) may begin encrypted communication with the second network device (application server) in response to using the selected private key. Further, the first network device signs first encrypted data sent to the second network device with the first CIMAC signature. Additionally, the second network device signs second encrypted data send to the first network device with the second CIMAC signature. Use of the CIMAC signature enable continuous authentication during the network session, as will be described with reference to FIG. 8B.

FIG. 8B is a process flow diagram illustrating a method for persistent authentication of encrypted communications between the mobile application and the application server of FIG. 8A according to an embodiment. At operation 860, the first network device (mobile application) generates a one-time password (OTP) usable to seed a CIMAC signature. The first network device may also seed, using the one-time password, generation of a first hash value including a first contextual-identifier message authentication code (CIMAC) signature. The first CIMAC, for example, encodes, within the first hash value, a first contextual hash-based message authentication code (HMAC) and a public key. At operation 862, the first network device (mobile application) transmits, via the gateway to the second network device (application server), first encrypted data signed with the first CIMAC signature, where the first CIMAC signature is to provide authentication of the first encrypted data. In one embodiment, the first CIMAC signature is appended to the first encrypted data. In another embodiment, the second CIAC signature is encoded within or combined with the encrypted data before being transmitted.

At operation 865, the gateway moves the authentication of the mobile application from OSI layer 7 to OSI 3 layer. Operation 865 may be performed because, in some embodiments, existing security policies are written at the network (or IP) layer (OSI layer 3) and can avoid being rewritten by moving the authentication from the application layer (OSI layer 7) to the network layer. This enables specific authentication, facilitated by the gateway, of the mobile application by the application server with the help of the DL server.

At operation 864, the first network device (mobile application) purges any cache private key(s) and a second hardware fingerprint for the second network device (application server) if the second network device is unreachable, e.g., no response received.

At operation 866, the second network device (application server) blocks communication with the first network device (mobile application) if such communication is not permitted. This may be determined via a look up of a block list of network devices, and determining that the first network device is on that list. This could be an attempted attack or spoof.

At operation 870, the second network device (application server) may perform a number of processes in order to authenticate the message or data received from the first network device (mobile application), e.g., by way of on-going authentication. This may include, but not be limited to, reading elements of a first hardware fingerprint of the first network device that was previously received from a distributed ledger server upon initiation of the encrypted communication and generating the one-time password. The second network device may then validate the first CIMAC signature using the elements of the first hardware fingerprint and the one-time password. The second network device may further increment the one-time password to generate a second one-time password, and seed a second CIMAC signature specific to the second network device using the second one-time password.

At operation 872, the second network device sends, via the gateway to the first network device, second encrypted data signed with the second CIMAC signature. At operation 874, the gateway moves authentication of the application server from OSI layer 3 (the network or IP layer) to the OSI layer 7 (the application layer), thereby moving authentication back to the mobile application to complete the secure handshake at the level of the first network device.

Once the first network device receives the second encrypted data, e.g., by way of a response to the first network device, at operation 875, the first network device performs a number of processes to authenticate the second encrypted data. To do so, the first network device may read elements of a second hardware signature of the second network device that was previously received from a distributed ledger server upon initiation of the encrypted communication. The first network device may further increment the one-time password to generate the second one-time password, and then validate the second CIMAC signature using the elements of the second hardware signature and the second one-time password.

At operation 880, the first network device (mobile application) compares a second network location of the second network device (application server) transmitted with the second encrypted data to one of a geo-fence, an Internet protocol address, or a domain name system (DNS) address for the second network device. In response to failing to validate the second network location, the first network device terminates the encrypted communication with the second network device.

At operation 885, in response to expiration of one of a public key or a hardware fingerprint used for initial authentication between the first network device (mobile application) and the second network device (application server): requiring the first network device to request a second public key and a second hardware fingerprint of the second network device from a distributed ledger server; requiring the second network device to request the second public key and a first hardware fingerprint of the first network device from the distributed ledger server; and mutually authenticating the first network device and the second network device with each using the second public key and one of the second hardware fingerprint and the first hardware fingerprint, respectively.

At operation 890, in response to a change in an item of information indexed against either of the first network location (of the first network device) or the second network location (of the second network device), notify the first network device and the second network device of the change within an expiration time of a record that is changed. This will enable keeping authentication information updated at the network devices that may continue to be used for on-going authentication. The expiration time is made to be shorter than a time required to spoof a connection to one of the network devices using outdated authentication information.

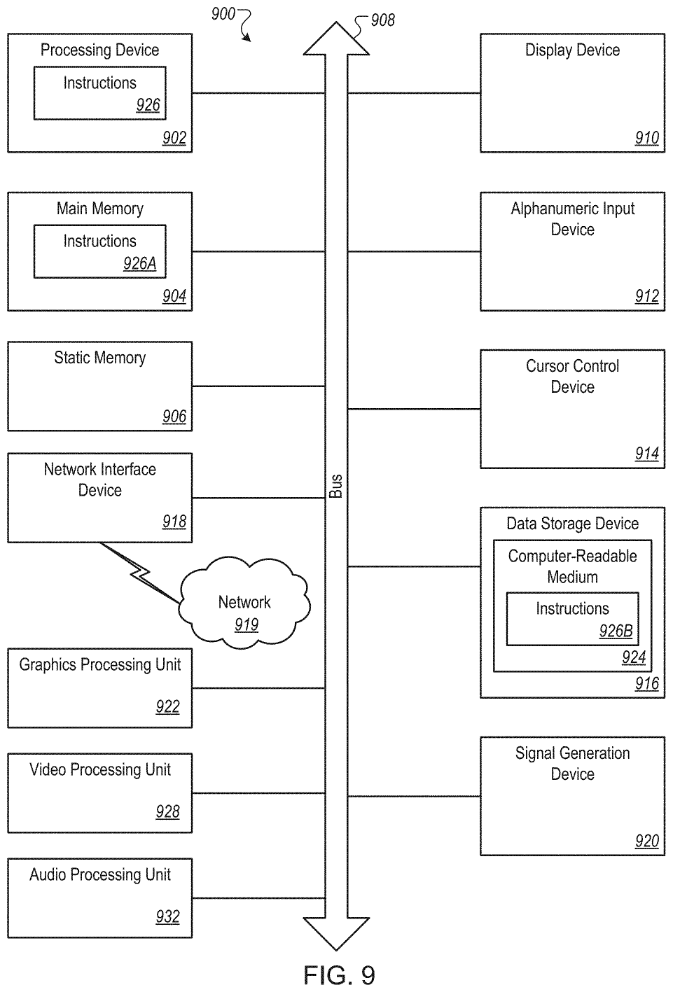

FIG. 9 illustrates a diagrammatic representation of a machine in the example form of a computing system 900 within which a set of instructions, for causing the machine to implement mutual authentication and encrypted communications according any one or more of the methodologies discussed herein. In alternative embodiments, the machine may be connected (e.g., networked) to other machines in a LAN, an intranet, an extranet, or the Internet. The machine may operate in the capacity of a server or a client device in a client-server network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The computing system 900 includes a processing device 902, main memory 904 (e.g., flash memory, dynamic random access memory (DRAM) (such as synchronous DRAM (SDRAM) or DRAM (RDRAM), etc.), a static memory 906 (e.g., flash memory, static random access memory (SRAM), etc.), and a data storage device 916, which communicate with each other via a bus 908.

Processing device 902 represents one or more general-purpose processing devices such as a microprocessor, central processing unit, or the like. More particularly, the processing device may be complex instruction set computing (CISC) microprocessor, reduced instruction set computer (RISC) microprocessor, very long instruction word (VLIW) microprocessor, or processor implementing other instruction sets, or processors implementing a combination of instruction sets. Processing device 902 may also be one or more special-purpose processing devices such as an application-specific integrated circuit (ASIC), a field programmable gate array (FPGA), a digital signal processor (DSP), network processor, or the like. In one embodiment, processing device 902 may include one or more processor cores. The processing device 902 is configured to execute the processing logic 926 for performing the operations discussed herein.

In one embodiment, processing device 902 can be part of a processor or an integrated circuit that includes the disclosed security applications. Alternatively, the computing system 900 can include other components as described herein.

The computing system 900 may further include a network interface device 918 communicably coupled to a network 919. The computing system 900 also may include a video display device 910 (e.g., a liquid crystal display (LCD) or a cathode ray tube (CRT)), an alphanumeric input device 912 (e.g., a keyboard), a cursor control device 914 (e.g., a mouse), a signal generation device 920 (e.g., a speaker), or other peripheral devices. Furthermore, computing system 900 may include a graphics processing unit 922, a video processing unit 928 and an audio processing unit 932. In another embodiment, the computing system 900 may include a chipset (not illustrated), which refers to a group of integrated circuits, or chips, that are designed to work with the processing device 902 and controls communications between the processing device 902 and external devices. For example, the chipset may be a set of chips on a motherboard that links the processing device 902 to very high-speed devices, such as main memory 904 and graphic controllers, as well as linking the processing device 902 to lower-speed peripheral buses of peripherals, such as USB, PCI or ISA buses.

The data storage device 916 may include a computer-readable storage medium 924 on which is stored software 926A embodying any one or more of the methodologies of functions described herein. The software 926A may also reside, completely or at least partially, within the main memory 904 as instructions and/or within the processing device 902 as processing logic 926 during execution thereof by the computing system 900; the main memory 904 and the processing device 902 also constituting computer-readable storage media.

The computer-readable storage medium 924 may also be used to store instructions 926B utilizing the processing device 902, and/or a software library containing methods that call the above applications. While the computer-readable storage medium 924 is shown in an example embodiment to be a single medium, the term “computer-readable storage medium” should be taken to include a single medium or multiple media (e.g., a centralized or distributed database, and/or associated caches and servers) that store the one or more sets of instructions. The term “computer-readable storage medium” shall also be taken to include any medium that is capable of storing, encoding or carrying a set of instruction for execution by the machine and that cause the machine to perform any one or more of the methodologies of the disclosed embodiments. The term “computer-readable storage medium” shall accordingly be taken to include, but not be limited to, solid-state memories, and optical and magnetic media.

While the disclosure has been described with respect to a limited number of embodiments, those skilled in the art will appreciate numerous modifications and variations therefrom. It is intended that the appended claims cover all such modifications and variations as fall within the true spirit and scope of this disclosure.

In the description herein, numerous specific details are set forth, such as examples of specific types of hardware and system configurations, specific hardware structures, specific instruction types, specific system components, and operation in order to provide a thorough understanding of the disclosure. It will be apparent, however, to one skilled in the art that these specific details need not be employed to practice the disclosure. In other instances, well known components or methods, such as specific and alternative hardware or software architectures, specific logic circuits/code for described algorithms, specific firmware code, specific interconnect operation, specific logic configurations, specific manufacturing techniques and materials, specific expression of algorithms in code, specific power down techniques/logic and other specific operational details of a computer system have not been described in detail in order to avoid unnecessarily obscuring the disclosure.

The embodiments are described with reference to mutual authentication of communication devices, such as in computing platforms or microprocessors. The embodiments may also be applicable to other types of integrated circuits and programmable logic devices. For example, the disclosed embodiments are not limited to desktop computer systems or portable computers. And may be also used in other devices, such as handheld devices, tablets, other thin notebooks, systems on a chip (SoC) devices, and embedded applications. Some examples of handheld devices include cellular phones, Internet protocol devices, digital cameras, personal digital assistants (PDAs), and handheld PCs. Embedded applications typically include a microcontroller, a digital signal processor (DSP), a system on a chip, network computers (NetPC), set-top boxes, network hubs, wide area network (WAN) switches, or any other system that can perform the functions and operations taught below. It is described that the system can be any kind of computer or embedded system. Moreover, the apparatuses, methods, and systems described herein are not limited to physical computing devices, but may also relate to software optimizations for energy conservation and efficiency.

Although the above examples describe instruction handling and distribution in the context of execution units and logic circuits, other embodiments of the disclosure can be accomplished by way of a data or instructions stored on a machine-readable, tangible medium, which when performed by a machine cause the machine to perform functions consistent with at least one embodiment of the disclosure. In one embodiment, functions associated with embodiments of the disclosure are embodied in machine-executable instructions. The instructions can be used to cause a general-purpose or special-purpose processor that is programmed with the instructions to perform the steps of the disclosure. Embodiments of the disclosure may be provided as a computer program product or software which may include a machine or computer-readable medium having stored thereon instructions which may be used to program a computer (or other electronic devices) to perform one or more operations according to embodiments of the disclosure. Alternatively, operations of embodiments of the disclosure might be performed by specific hardware components that contain fixed-function logic for performing the operations, or by any combination of programmed computer components and fixed-function hardware components.

Instructions used to program logic to perform embodiments of the disclosure can be stored within a memory in the system, such as DRAM, cache, flash memory, or other storage. Furthermore, the instructions can be distributed via a network or by way of other computer readable media. Thus a machine-readable medium may include any mechanism for storing or transmitting information in a form readable by a machine (e.g., a computer), but is not limited to, floppy diskettes, optical disks, Compact Disc, Read-Only Memory (CD-ROMs), and magneto-optical disks, Read-Only Memory (ROMs), Random Access Memory (RAM), Erasable Programmable Read-Only Memory (EPROM), Electrically Erasable Programmable Read-Only Memory (EEPROM), magnetic or optical cards, flash memory, or a tangible, machine-readable storage used in the transmission of information over the Internet via electrical, optical, acoustical or other forms of propagated signals (e.g., carrier waves, infrared signals, digital signals, etc.). Accordingly, the computer-readable medium includes any type of tangible machine-readable medium suitable for storing or transmitting electronic instructions or information in a form readable by a machine (e.g., a computer).

A design may go through various stages, from creation to simulation to fabrication. Data representing a design may represent the design in a number of manners. First, as is useful in simulations, the hardware may be represented using a hardware description language or another functional description language. Additionally, a circuit level model with logic and/or transistor gates may be produced at some stages of the design process. Furthermore, most designs, at some stage, reach a level of data representing the physical placement of various devices in the hardware model. In the case where conventional semiconductor fabrication techniques are used, the data representing the hardware model may be the data specifying the presence or absence of various features on different mask layers for masks used to produce the integrated circuit. In any representation of the design, the data may be stored in any form of a machine readable medium. A memory or a magnetic or optical storage such as a disc may be the machine readable medium to store information transmitted via optical or electrical wave modulated or otherwise generated to transmit such information. When an electrical carrier wave indicating or carrying the code or design is transmitted, to the extent that copying, buffering, or re-transmission of the electrical signal is performed, a new copy is made. Thus, a communication provider or a network provider may store on a tangible, machine-readable medium, at least temporarily, an article, such as information encoded into a carrier wave, embodying techniques of embodiments of the disclosure.

A module as used herein refers to any combination of hardware, software, and/or firmware. As an example, a module includes hardware, such as a micro-controller, associated with a non-transitory medium to store code adapted to be executed by the micro-controller. Therefore, reference to a module, in one embodiment, refers to the hardware, which is specifically configured to recognize and/or execute the code to be held on a non-transitory medium. Furthermore, in another embodiment, use of a module refers to the non-transitory medium including the code, which is specifically adapted to be executed by the microcontroller to perform predetermined operations. And as can be inferred, in yet another embodiment, the term module (in this example) may refer to the combination of the microcontroller and the non-transitory medium. Often module boundaries that are illustrated as separate commonly vary and potentially overlap. For example, a first and a second module may share hardware, software, firmware, or a combination thereof, while potentially retaining some independent hardware, software, or firmware. In one embodiment, use of the term logic includes hardware, such as transistors, registers, or other hardware, such as programmable logic devices.

Use of the phrase ‘configured to,’ in one embodiment, refers to arranging, putting together, manufacturing, offering to sell, importing and/or designing an apparatus, hardware, logic, or element to perform a designated or determined task. In this example, an apparatus or element thereof that is not operating is still ‘configured to’ perform a designated task if it is designed, coupled, and/or interconnected to perform said designated task. As a purely illustrative example, a logic gate may provide a 0 or a 1 during operation. But a logic gate ‘configured to’ provide an enable signal to a clock does not include every potential logic gate that may provide a 1 or 0. Instead, the logic gate is one coupled in some manner that during operation the 1 or 0 output is to enable the clock. Note once again that use of the term ‘configured to’ does not require operation, but instead focus on the latent state of an apparatus, hardware, and/or element, where in the latent state the apparatus, hardware, and/or element is designed to perform a particular task when the apparatus, hardware, and/or element is operating.

Furthermore, use of the phrases ‘to,’ capable of/to,′ and/or ‘operable to,’ in one embodiment, refers to some apparatus, logic, hardware, and/or element designed in such a way to enable use of the apparatus, logic, hardware, and/or element in a specified manner. Note as above that use of ‘to,’ capable to,′ or ‘operable to,’ in one embodiment, refers to the latent state of an apparatus, logic, hardware, and/or element, where the apparatus, logic, hardware, and/or element is not operating but is designed in such a manner to enable use of an apparatus in a specified manner.

A value, as used herein, includes any known representation of a number, a state, a logical state, or a binary logical state. Often, the use of logic levels, logic values, or logical values is also referred to as 1's and 0's, which simply represents binary logic states. For example, a 1 refers to a high logic level and 0 refers to a low logic level. In one embodiment, a storage cell, such as a transistor or flash cell, may be capable of holding a single logical value or multiple logical values. However, other representations of values in computer systems have been used. For example the decimal number ten may also be represented as a binary value of 1010 and a hexadecimal letter A. Therefore, a value includes any representation of information capable of being held in a computer system.

Moreover, states may be represented by values or portions of values. As an example, a first value, such as a logical one, may represent a default or initial state, while a second value, such as a logical zero, may represent a non-default state. In addition, the terms reset and set, in one embodiment, refer to a default and an updated value or state, respectively. For example, a default value potentially includes a high logical value, i.e. reset, while an updated value potentially includes a low logical value, i.e. set. Note that any combination of values may be utilized to represent any number of states.

The embodiments of methods, hardware, software, firmware or code set forth above may be implemented via instructions or code stored on a machine-accessible, machine readable, computer accessible, or computer readable medium which are executable by a processing element. A non-transitory machine-accessible/readable medium includes any mechanism that provides (i.e., stores and/or transmits) information in a form readable by a machine, such as a computer or electronic system. For example, a non-transitory machine-accessible medium includes random-access memory (RAM), such as static RAM (SRAM) or dynamic RAM (DRAM); ROM; magnetic or optical storage medium; flash memory devices; electrical storage devices; optical storage devices; acoustical storage devices; other form of storage devices for holding information received from transitory (propagated) signals (e.g., carrier waves, infrared signals, digital signals); etc., which are to be distinguished from the non-transitory mediums that may receive information there from.

Instructions used to program logic to perform embodiments of the disclosure may be stored within a memory in the system, such as DRAM, cache, flash memory, or other storage. Furthermore, the instructions can be distributed via a network or by way of other computer readable media. Thus a machine-readable medium may include any mechanism for storing or transmitting information in a form readable by a machine (e.g., a computer), but is not limited to, floppy diskettes, optical disks, Compact Disc, Read-Only Memory (CD-ROMs), and magneto-optical disks, Read-Only Memory (ROMs), Random Access Memory (RAM), Erasable Programmable Read-Only Memory (EPROM), Electrically Erasable Programmable Read-Only Memory (EEPROM), magnetic or optical cards, flash memory, or a tangible, machine-readable storage used in the transmission of information over the Internet via electrical, optical, acoustical or other forms of propagated signals (e.g., carrier waves, infrared signals, digital signals, etc.). Accordingly, the computer-readable medium includes any type of tangible machine-readable medium suitable for storing or transmitting electronic instructions or information in a form readable by a machine (e.g., a computer).

Reference throughout this specification to “one embodiment” or “an embodiment” means that a particular feature, structure, or characteristic described in connection with the embodiment is included in at least one embodiment of the disclosure. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

In the foregoing specification, a detailed description has been given with reference to specific exemplary embodiments. It will, however, be evident that various modifications and changes may be made thereto without departing from the broader spirit and scope of the disclosure as set forth in the appended claims. The specification and drawings are, accordingly, to be regarded in an illustrative sense rather than a restrictive sense. Furthermore, the foregoing use of embodiment and other exemplarily language does not necessarily refer to the same embodiment or the same example, but may refer to different and distinct embodiments, as well as potentially the same embodiment.

Some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is, here and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared and otherwise manipulated. It has proven convenient at times, principally for reasons of common usage, to refer to these signals as bits, values, elements, symbols, characters, terms, numbers or the like. The blocks described herein can be hardware, software, firmware or a combination thereof.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “defining,” “receiving,” “determining,” “issuing,” “linking,” “associating,” “obtaining,” “authenticating,” “prohibiting,” “executing,” “requesting,” “communicating,” or the like, refer to the actions and processes of a computing system, or similar electronic computing device, that manipulates and transforms data represented as physical (e.g., electronic) quantities within the computing system's registers and memories into other data similarly represented as physical quantities within the computing system memories or registers or other such information storage, transmission or display devices.

The words “example” or “exemplary” are used herein to mean serving as an example, instance or illustration. Any aspect or design described herein as “example” or “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or.” That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an embodiment” or “one embodiment” or “an embodiment” or “one embodiment” throughout is not intended to mean the same embodiment or embodiment unless described as such. Also, the terms “first,” “second,” “third,” “fourth,” etc. as used herein are meant as labels to distinguish among different elements and may not necessarily have an ordinal meaning according to their numerical designation.

What is claimed is:

1. A method comprising:
requesting, from a distributed ledger server by a first network device that is requesting to communicate with a second network device, a public key and a second hardware fingerprint associated with a second network location of the second network device;
receiving, in response to the distributed ledger server authenticating the first network device, the public key and the second hardware fingerprint associated with the second network location;
generating, by the first network device, a first contextual-identifier message authentication code (CIMAC) signature that encodes, within a first hash value, a first contextual hash-based message authentication code (HMAC), a one-time password, and the public key;
requesting, by the first network device using the first CIMAC signature, encrypted communication with the second network device;
validating, by the first network device using the public key, the second hardware fingerprint, and the second network location, a response from the second network device that includes a second CIMAC signature specific to the second network device; and
beginning, between the first network device with the second network device, encrypted communication in response to validating the second CIMAC signature.

2. The method of claim 1, further comprising, in response to the second network device determining the second network device is not authorized to communicate with the first network device, disallowing the encrypted communication.

3. The method of claim 1, further comprising the first network device:
estimating a first geo-location of the first network device based on a first network location of the first network device;
generating a first hardware signature of the first network device; and
generating the first contextual HMAC based on taking a hash of a combination of the first geo-location, the first hardware signature, an application identifier, and a network session identifier of the first network device.

4. The method of claim 3, further comprising, during the encrypted communication:
detecting, by the first network device, a change in the HMAC due to a change in one of the first hardware signature, the first network location, the application identifier, or the network session identifier during a network session; and
terminating, by the first network device, the encrypted communication with the second network device.

5. The method of claim 1, further comprising the second network device:
requesting, from the distributed ledger server, the public key and a first hardware fingerprint associated with a first network location of the first network device;
receiving, in response to the distributed ledger server authenticating the second network device, the public key and the first hardware fingerprint associated with the first network location; and
validating, before beginning the encrypted communication, the first CIMAC signature using at least the public key, the first hardware fingerprint, and the first network location.

6. The method of claim 1, the method further comprising:
sending, by the first network device in response to the second network device validating the first CIMAC signature, a selection of a private keys to the second network device;
selecting, by the second network device, a private key;
using the private key for the encrypted communication between the first network device and the second network device;
signing, by the first network device with the first CIMAC signature, first encrypted data sent to the second network device; and
signing, by the second network device with the second CIMAC signature specific to the second network device, second encrypted data sent to the first network device.

7. The method of claim 6, further comprising terminating the encrypted communication between the first network device and the second network device in response to a change to one of the first CIMAC signature or the second CIMAC signature.

8. The method of claim 1, wherein generating the first CIMAC signature further comprises also encoding, within the first hash value, a first secret key based on a hash of a combination of a previous encryption key and one or more network parameters associated with a previous network session of the first network device.

9. A method comprising:
generating, by a first network device in encrypted communication with a second network device, a one-time password;
seeding, by the first network device using the one-time password, generation of a first hash value comprising a first contextual-identifier message authentication code (CIMAC) signature, wherein the first CIMAC encodes, within the first hash value, a first contextual hash-based message authentication code (HMAC) and a public key; and
transmitting, by the first network device to the second network device, first encrypted data signed with the first CIMAC signature, wherein the first CIMAC signature is to provide authentication of the first encrypted data.

10. The method of claim 9, further comprising, in response to the second network device being unreachable, the first network device:
purging any cached private keys and a second hardware fingerprint of the second network device; and
terminating the encrypted communication with the second network device.

11. The method of claim 9, further comprising the second network device:
determining, via a look up of a black list of network device, that communication with the first network device is not permitted; and
blocking the encrypted communication by dropping packets directed to the first network device.

12. The method of claim 9, further comprising the second network device:
reading elements of a first hardware fingerprint of the first network device that was previously received from a distributed ledger server upon initiation of the encrypted communication;
generating the one-time password; and
validating the first CIMAC signature using the elements of the first hardware fingerprint and the one-time password.

13. The method of claim 9, further comprising the second network device:
incrementing the one-time password to generate a second one-time password;
seeding a second CIMAC signature specific to the second network device using the second one-time password; and
sending, to the first network device, second encrypted data signed with the second CIMAC signature.

14. The method of claim 13, further comprising the first network device:
reading elements of a second hardware fingerprint of the second network device that was previously received from a distributed ledger server upon initiation of the encrypted communication;
incrementing the one-time password to generate the second one-time password; and
validating the second CIMAC signature using the elements of the second hardware fingerprint and the second one-time password.

15. The method of claim 14, further comprising the first network device:
comparing a second network location of the second network device transmitted with the second encrypted data to one of a geo-fence, an Internet protocol address, or a domain name system (DNS) address for the second network device; and
in response to failing to validate the second network location, terminating the encrypted communication with the second network device.

16. The method of claim 9, further comprising, in response to expiration of one of a public key or a hardware fingerprint used for initial authentication between the first network device and the second network device:
requiring the first network device to request a second public key and a second hardware fingerprint of the second network device from a distributed ledger server;
requiring the second network device to request the second public key and a first hardware fingerprint of the first network device from the distributed ledger server; and
mutually authenticating the first network device and the second network device with each using the second public key and one of the second hardware fingerprint and the first hardware fingerprint, respectively.

17. The method of claim 9, further comprising:
indexing, by a distributed ledger server that facilitates authentication between the first network device and the second network device, a first network location of the first network device with a first hardware fingerprint of the first network device and a public key used to initiate the encrypted communication;
indexing, by the distributed ledger server, a second network location of the second network device with a second hardware fingerprint of the second network device and the public key used to initiate the encrypted communication; and
in response to a change in an item of information indexed against either of the first network location or the second network location, notify the first network device and the second network device of the change within an expiration time of a record that is changed.

18. A distributed ledger server comprising:
a memory to store a database of network locations associated with registered network devices, the network locations each indexed against a public key and a hardware fingerprint; and
a processing device coupled to the memory, the processing device to:
receive a request from a first network device to look up a public key and a second hardware fingerprint for a second network device with which the first network device requests to communicate;
authenticate the first network device based on at least the network location of the first network device and as having previously registered;
retrieve, from the database, the public key and the second hardware fingerprint that are indexed in association with the second network device; and
respond, to the request of the first network device upon successful authentication of the first network device, by transmission of the public key and the second hardware fingerprint to the first network device.

19. The distributed ledger server of claim 18, wherein the processing device is further to:
receive a request from the second network device to look up a public key and a first hardware fingerprint for a first network device;
authenticate the second network device based on at least the network location of the second network device and as having previously registered;
retrieve the public key and the first hardware fingerprint that are indexed in association with the first network device; and
respond, to the request of the second network device upon successful authentication of the second network device, by sending the public key and the first hardware fingerprint to the second network device.

20. The distributed ledger server of claim 18, wherein the database is further to index, again the network locations of the authenticated network devices, at least one of encryption keys, domain names, geographic locations estimated from the network locations, and a set of vaulting keys for entry into a distributed ledger.

21. The distributed ledger server of claim 18, wherein the processing device is further to:
receive, from the first network device, a first contextual-identifier message authentication code (CIMAC) signature that encodes, within a first hash value, a first contextual hash-based message authentication code (HMAC), a one-time password, the public key, and a first secret key based on a hash of a combination of a previous encryption key and one or more network parameters associated with a previous network session of the first network device;
retrieve the first secret key from the CIMAC signature;
generate a second secret key from a hash of the combination of the previous encryption key and the one or more network parameters retrieved from the first network device during the previous network session; and
in response to the second secret key not matching the first secret key, denying authentication of the first network device for communication with the second network device.
